(19) United States
(12) Patent Application Publication
(10) Pub. No.: US 2026/0246624 A1
(43) Pub. Date: Aug. 20, 2026

(54) METHOD FOR THE IMPLEMENTATION OF LEFT-NODE AUTHENTICATION IN HASH-BASED SIGNATURES XMSS AND LMS

(71) Applicant: PQSECURE TECHNOLOGIES, LLC, Boca Raton, FL (US)

(72) Inventor: Furkan Karabulut, Raleigh, NC (US)

(73) Assignee: PQSECURE TECHNOLOGIES, LLC, Boca Raton, FL (US)

(21) Appl. No.: 18/842,308

(22) PCT Filed: Jun. 30, 2023
(86) PCT No.: PCT/US2023/026690

§ 371 Date: Aug. 28, 2024

(51) Int. Cl. H04L 9/08; H04L 9/32

(52) U.S. Cl. CPC H04L 9/0852; H04L 9/3236; H04L 9/3247

(57) ABSTRACT

A computer-implemented method utilizing an algorithmic-based approach to find a memory-efficient left-node authentication path in XMSS and LMS post-quantum cryptography algorithms that includes providing a computer with at least one processor operably configured to carry out a post-quantum cryptographic authentication session having an authentication path and operably configured to execute computer readable instructions having an algorithm with three subroutines, a first subroutine that includes generating an index value integer of authentication path nodes within the authentication path needing updating, a second subroutine that includes initializing a left node variable and initializing a right node variable based on a generated leaf position, and a third subroutine that includes iterating the left and right node variables with a merging operation until reaching the index value integer and swapping the left node variable with an index^{th} node within the authentication path.

### FIELD OF THE INVENTION

The present invention relates generally to methods and systems directed toward post-quantum cryptographic authentication and, more particularly, relates to post-quantum cryptographic authentication in Extended Merkle Signature Scheme and Leighton-Micali Hash-Based Signatures.

### BACKGROUND OF THE INVENTION

The invention described herein is related to the field of computer security, especially to the field of post-quantum cryptographic authentication methods with stateful hash-based signatures known as the Extended Merkle Signature Scheme (XMSS) and Leighton-Micali Hash-Based Signatures (LMS). Cryptography is a key backbone of processing systems by securing the communications between various hard mathematical problems. More specifically, deploying cryptosystems in digital devices achieves essential information security properties including data confidentiality, data integrity, authentication, and non-repudiation. Authentication is provided through digital signatures. Current classical digital signatures such as Rivest-Shamir-Adleman (RSA) and Elliptic Curve Digital Signature (ECDSA) will be broken by cryptographically relevant large-scale quantum computers. XMSS and LMS belong to a family of quantum-safe stateful hash-based signatures used for authentication. Their signature sizes are relatively small compared to the other post-quantum digital signature schemes such as lattice-based cryptography. Moreover, XMSS and LMS are secure, making only mild assumptions on the underlying hash function. Their hardness does not rely on the collision resistance of the used hash functions, but rather on weaker properties. XMSS and LMS are stateful signature schemes, meaning that the private key changes with every signature generation.

Both algorithms' main principle is passing a secret through hash chains and then generating a public key. They have three routines: Key generation, signature generation, and verification. The key generation first gets a secret seed and then extends it to a secret key. Second, it passes the secret key through hash chains and then generates a public key, which is also called root. The signature generation follows the same steps but does not complete the hash chain until the root generation. It completes the chain with the length of the message and the output of the completed chain is called the signature.

The verification routine gets the signature and then feeds the chain as the input, but it does not start from the beginning, it starts from the chain step where the signature is left. When the chain is completed, the verification routine obtains a root. The verification returns true if the obtained root is the same as the public key. Otherwise, it returns false. The process requires a lot of memory access and hence memory efficient implementations of XMSS and LMS may find utility in computer-based secure quantum-safe communication systems and methods.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments further and explain various principles and advantages all in accordance with the present invention.

FIG. 1 is a diagram depicting a Merkle tree whose height is 4 and whose leaf number is 16 and depicts the tree's root, the authentication (or “auth.”) path nodes, first leaf nodes used to obtain the root via hash operations, and the hash-generated nodes, or the hash operations generating nodes until the root is obtained;

FIG. 2 is a diagrams depicting how the authentication path is updated when the first leaf node changes, i.e., since the first leaf node used is the 5th leaf of the tree, the authentication path is different from the 4th element authentication path (depicted in FIG. 1);

FIG. 3 is a block diagram depicting an exemplary method for the implementation of left-node authentication in hash-based signatures XMSS and LMS according to one embodiment of the present invention; and

FIG. 4 is a process flow diagram depicting a method for the implementation of left-node authentication in hash-based signatures XMSS and LMS according to one embodiment of the present invention.

### SUMMARY OF THE INVENTION

The present invention provides a method and architecture to update left authentication path nodes in a memory-efficient manner. Said another way, the present invention provides a method and system utilizing an algorithmic-based approach to find a memory-efficient authentication path in a post-quantum cryptographic authentication for XMSS and LMS.

More specifically, the Merkle tree is the last tree in both XMSS and LMS. During the signature generation, the algorithms return an authentication path along with the signature. Later, the authentication path is used to verify the signature. The present invention provides a memory-efficient solution for left node updates for the authentication path.

With the foregoing and other objects in view, there is provided, in accordance with the invention, a computer-implemented method utilizing an algorithmic-based approach to find a memory-efficient left-node authentication path in XMSS and LMS post-quantum cryptography algorithms including the steps of providing a computer with at least one processor operably configured to carry out a post-quantum cryptographic authentication session having an authentication path and operably configured to execute computer readable instructions having an algorithm with three subroutines. The process includes executing a first subroutine of the three subroutines that includes generating an index value integer of authentication path nodes within the authentication path needing updating, executing a second subroutine of the three subroutines that includes initializing a left node variable and initializing a right node variable based on a generated leaf position, and executing a third subroutine of the three subroutines that includes iterating the left and right node variables with a merging operation until reaching the index value integer and swapping the left node variable with an index^{th} node within the authentication path.

In accordance with another feature, an embodiment of the present invention includes executing the third subroutine that includes computing an output of the merging operation of the left and right node variables with a node generated from the second subroutine based on the authentication path node position.

In accordance with a further feature of the present invention, the first subroutine and the second subroutine are executed in parallel and independently.

Also in accordance with present invention, a method for utilizing an algorithmic-based approach to find a memory-efficient left-node authentication path in XMSS and LMS post-quantum cryptography algorithms is disclosed that includes providing an index calculator with a memory storage unit or utilizing arithmetic operations, the index calculator generating an index value integer of authentication path nodes within an authentication path needing updating in a XMSS algorithm or a LMS algorithm, providing a Merkle leaf generator that initializes a left node variable and initializes a right node variable based on a generated leaf position, and providing finite-state machine that iterates the left and right node variables with a merging operation until reaching the index value integer and swapping the left node variable with an index^{th} node within the authentication path.

Although the invention is illustrated and described herein as embodied in a method and system for the implementation of left-node authentication in hash-based signatures XMSS and LMS, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### DETAILED DESCRIPTION

While the specification concludes with claims defining the features of the invention that are regarded as novel, it is believed that the invention will be better understood from a consideration of the following description in conjunction with the drawing figures, in which reference numerals are carried forward. It is to be understood that the disclosed embodiments are merely exemplary of the invention, which can be embodied in various forms.

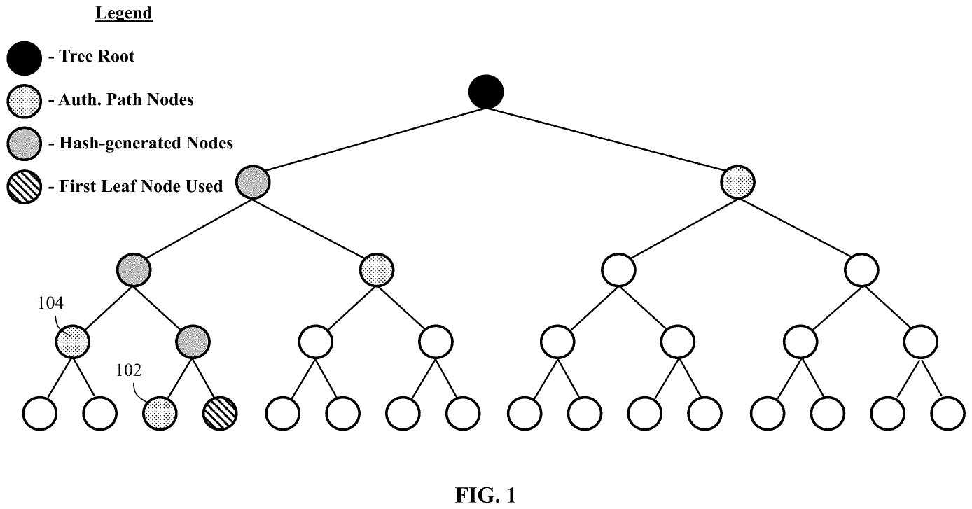

With reference to FIG. 1, a Merkle tree is depicted alongside the authentication path for the 4^{th} signature, i.e., the first leaf node used. The signature verification algorithm generates the fourth leaf and then combines this leaf with the authentication path nodes. This combining operation is called node merging. The node merging operation output generates a path termed hash-generated nodes to obtain the tree root. If the authentication path and signature are valid, the obtained root equals the public key. Therefore, the signature generation needs to return the authentication path.

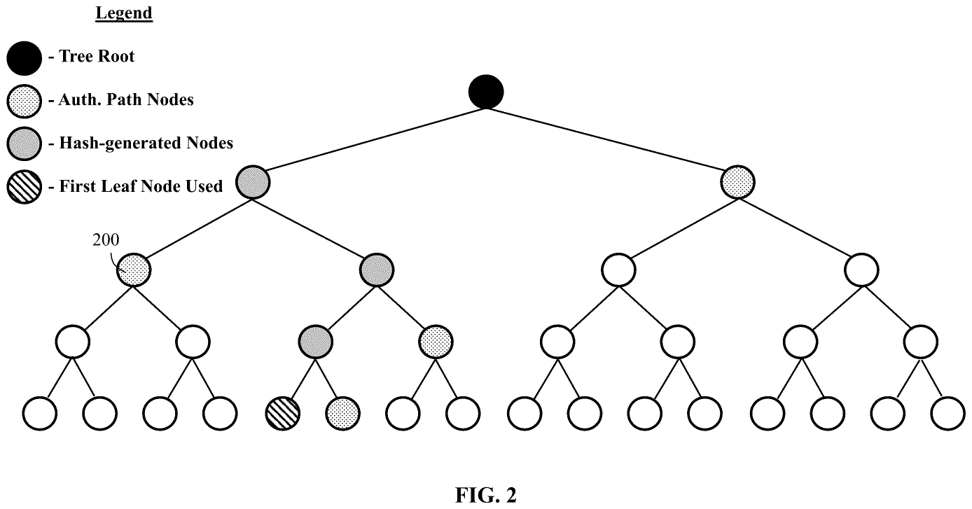

With reference to FIG. 2, a Merkle tree is depicted alongside the authentication path for the 5^{th} signature, i.e., the first leaf node used. This authentication path is different from the previously discussed authentication path. Since the signature leaf is updated from the 4^{th} to the 5^{th}, the authentication path nodes also are updated. These updates are categorized into two groups: Left node and right node updates. To that end, the present invention provides a memory-efficient solution for the left node updates for the authentication path.

With reference below to the exemplary pseudo-code and algorithm, said code and algorithm effectuates an update of the left nodes of the authentication path. This algorithm has three sub-routines. The first for-loop is the first sub-routine generating an index value that determines the authentication node's position to be updated. For example, FIG. 2 shows an updated authentication path version that is presented in FIG. 1. FIG. 1 has two left authentication path nodes, i.e., nodes 102, 104, in the authentication path at the 0^{th} and 1^{st} levels of the tree. When there is a new signature generation, the initiative leaf number is updated from 4^{th} to 5^{th}. Hence, the authentication path requires an update too. The first sub-routine returns the 2, meaning that the second level node should be left side and requires an update. As a result, FIG. 2 has only one left node, i.e., node 200, at the second level. Note that every new signature generation requires one left-node update in the authentication path.

After finding which node requires an update, the second sub-routine generates a leaf to initiate the update sequence. This sub-routine also determines whether the generated leaf is on the left side or the right side. The left and right position is important because hashing two-digit hex values 0XEF and 0xFE gives different results where each hex digit simply represents a node. The given hex values are just an example since each node could be either 192-bit or 256-bit values. If the first sub-routine returns an index value of 0, the generated update will be the left authentication node at the 0th level of the tree. Then, the algorithm does not enter the following sub-routine.

This second sub-routine is followed by a third subroutine, i.e., the last for-loop or the last sub-routine. This loop starts from 1 and goes up to the index value generated in the first routine. At the last iteration, the “left” value is the left node that is swapped with the existing index^{th} of the authentication path at the end of the algorithm. Each iteration requires an authentication path node to perform a node merging operation. The initial merging operation is computed with the first authentication path and the node generated from the second sub-routine by considering their left to right positions. The following iterations perform the merging operation with the next authentication path and the node generated with the previous iteration, the output of “mergeNode” function. To that end, an algorithm of left node update for authentication path is depicted below.

```
Input: The leaf index, l_{ind}
Input: The authentication node list, Auth
Output: The left authentication node left
Output: The height of Merkle tree HEIGHT
  for i from HEIGHT to 0 do
    if (l_{ind} − 2ⁱ) < 0 then
      index = i
      break
    else
      index = i
      point = l_{ind} − 2ⁱ − 1
      point =mod(point, 2ⁱ⁺¹)
      if (point = = 0 then
        break
      end if
    end if
  end for
  if (isLeft(l_{ind}) then
    left = generateLeaf(l_{ind})
    right = Auth[0]
  else
    left = Auth[0]
    right = generateLeaf(l_{ind})
  end if
  for i from 1 to index do
    if (isLeft(Auth[i]) then
      left = mergeNode(left, right)
      right = Auth[i]
    else
      right = mergeNode(left, right)
      left = Auth[i]
    end if
  end for
  return left
```

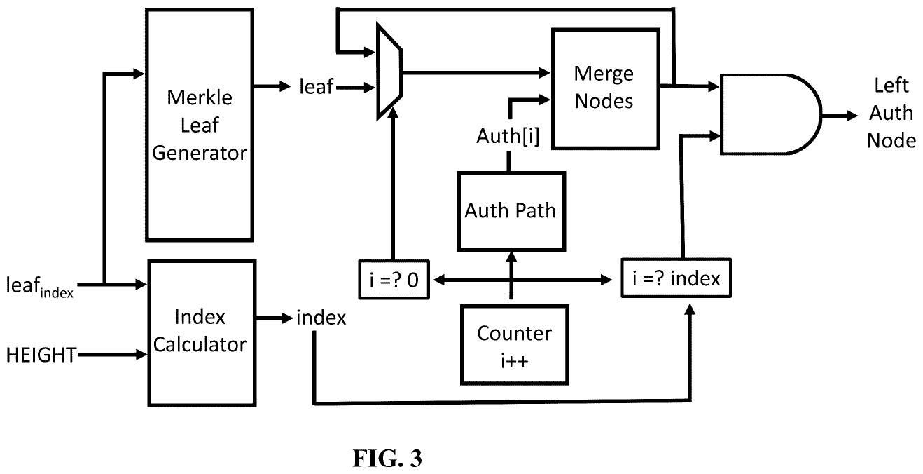

FIG. 3 presents an implementation block diagram for the proposed method. The diagram flow is from left to right. The first step is to generate the index value from the given height and corresponding Merkle leaf number. This leaf number is also used to generate a leaf that is used to perform a node merging operation if it is needed. The diagram also has a counter to traverse the existing authentication path nodes. It starts from 0 and goes up to the index value. This counter value is used to call the corresponding authentication path node. This first path node enters the node merging operation with the generated leaf for the counter “0”. Later, the other authentication path nodes enter the node merging operation with the previous output of the Merge Node module. This sequence continues until the counter value equals the index value. When the counter reaches the index value, the Merge Node module is returned as the new left node in the authentication path.

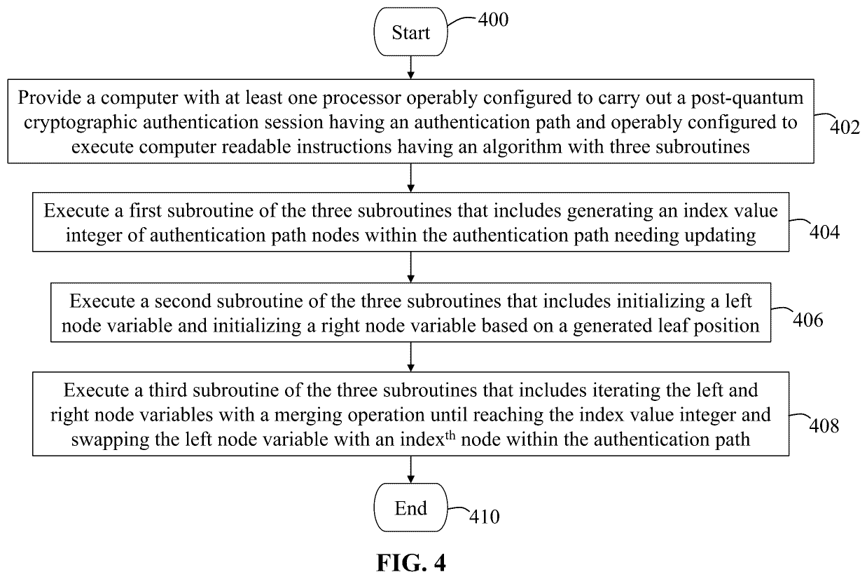

With reference to FIG. 4, a process flow diagram depicting a method for the implementation of left-node authentication in hash-based signatures XMSS and LMS is shown. Said differently, the process depicts a computer-implemented method utilizing an algorithmic-based approach to find a memory-efficient left-node authentication path in XMSS and LMS post-quantum cryptography algorithms, wherein the process starts at step 400 and immediately proceeds to the step 402 of providing a computer with at least one processor operably configured to carry out a post-quantum cryptographic authentication session having an authentication path and operably configured to execute computer readable instructions having an algorithm with three subroutines (as exemplified in code above). In hardware, the process may include providing an index calculator with a memory storage unit or utilizing arithmetic operations, the index calculator generating an index value integer of authentication path nodes within an authentication path needing updating in a XMSS algorithm or a LMS algorithm.

Next, the process includes step 404 of executing a first subroutine of the three subroutines that includes generating an index value integer of authentication path nodes within the authentication path needing updating. Additionally, the process may include providing a Merkle leaf generator that initializes a left node variable and initializes a right node variable based on a generated leaf position. The process will proceed to step 406 of executing a second subroutine of the three subroutines that includes initializing a left node variable and initializing a right node variable based on a generated leaf position. In some embodiments, the first subroutine and the second subroutine are executed in parallel and independently for efficiency.

The process may proceed to step 408 of executing a third subroutine of the three subroutines that includes iterating the left and right node variables with a merging operation until reaching the index value integer and swapping the left node variable with an index^{th} node within the authentication path. Said differently, the process includes executing the third subroutine that includes computing an output of the merging operation of the left and right node variables with a node generated from the second subroutine based on the authentication path node position. The process may also include providing finite-state machine that iterates the left and right node variables with a merging operation until reaching the index value integer and swapping the left node variable with an index^{th} node within the authentication path. One exemplary definition of a “finite-state-machine” is a mathematical model of computation which is an abstract machine that can be in exactly one of a finite number of states at any given time. An abstract machine is a theoretical model that allows for a detailed and precise analysis of how a computer system functions, i.e., allowing step-by-step execution of programs. The are “abstract” in that they ignore many aspects of actual (hardware) machines. Said generally, the present invention carries out two tasks, one for right nodes and another for lefts nodes in the most memory-efficient manner, wherein the prior art known methods store every possible part left node in advance or requires a dedicated memory storage unit to do so. The process may terminate at step 410.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A computer-implemented method utilizing an algorithmic-based approach to find a memory-efficient left-node authentication path in XMSS and LMS post-quantum cryptography algorithms comprising the steps of:
providing a computer with at least one processor operably configured to carry out a post-quantum cryptographic authentication session having an authentication path of a Merkle tree and operably configured to execute computer readable instructions having an algorithm with three subroutines configured to update left-node authentication in XMSS and LMS post-quantum cryptography algorithms;
executing a first subroutine of the three subroutines that includes generating an authentication node index value integer of authentication path nodes within the authentication path needing updating;
updating, if the generated authentication node index value integer is zero, a left authentication node at a 0th level of the Merkle tree and not proceeding with execution of a second subroutine of the three subroutines;
executing, if the generated authentication node index value integer is greater than zero, the second subroutine of the three subroutines that includes initializing a left node variable and initializing a right node variable based on a generated leaf position; and
executing a third subroutine of the three subroutines that includes iterating the left and right node variables with a merging operation until reaching the authentication node index value integer and swapping the left node variable with an indexth node within the authentication path.

2. The computer-implemented method according to claim 1, further comprising:
executing the third subroutine that includes computing an output of the merging operation of the left and right node variables with a node generated from the second subroutine based on the authentication path node position.

3. The computer-implemented method according to claim 1, wherein the first subroutine and the second subroutine are executed in parallel and independently.

4. A method for utilizing an algorithmic-based approach to find a memory-efficient left-node authentication path in XMSS and LMS post-quantum cryptography algorithms comprising:
providing an index calculator with a memory storage unit or utilizing arithmetic operations, the index calculator generating an authentication node index value integer of authentication path nodes within a left-node authentication path of a Merkle tree needing updating in a XMSS algorithm or a LMS algorithm and updating, if the generated authentication node index value integer is zero, a left authentication node at a 0th level of the Merkle tree without further update of any node within the authentication path;
providing, if the generated authentication node index value integer is greater than zero, a Merkle leaf generator that initializes a left node variable and initializes a right node variable based on a generated leaf position; and
providing finite-state machine that iterates the left and right node variables with a merging operation until reaching the authentication node index value integer and swapping the left node variable with an indexth node within the authentication path.
